(19) United States
(12) Patent Application Publication
(10) Pub. No.: US 2026/0212224 A1
(43) Pub. Date: Jul. 23, 2026

(54) METHOD, CLIENT DEVICE AND SERVER FOR DISTRIBUTED COLLABORATIVE INFERENCE

(71) Applicant: UIF (University Industry Foundation), Yonsei University, Seoul (KR)

(72) Inventors: Shiho KIM, Incheon (KR); Jun Yong LEE, Incheon (KR); Jei Hee CHO, Incheon (KR)

(73) Assignee: UIF (University Industry Foundation), Yonsei University, Seoul (KR)

(21) Appl. No.: 19/435,152

(22) Filed: Dec. 29, 2025

(30) Foreign Application Priority Data
Jan. 21, 2025 (KR) 10-2025-0008890

(51) Int. Cl. G06N 5/04; G06N 3/0455

(52) U.S. Cl. CPC G06N 5/04; G06N 3/0455

(57) ABSTRACT

A method for collaborative inference using a client device and a server includes: receiving, by the client device, first input data; generating, by the client device, a first embedding vector by inputting the first input data into a task-specific module; generating, by the server, a second embedding vector by inputting the first embedding vector into a task non-specific module; and producing, by the client device, a final inference result by inputting the second embedding vector into a decoding module.

### CROSS REFERENCE TO RELATED APPLICATIONS

The present application claims the benefit of and priority to Korean Patent Application No. 10-2025-0008890, filed Jan. 21, 2025, the entire contents of all of which are incorporated herein by reference for all purposes.

### BACKGROUND

### Technical Field

The present disclosure relates to a collaborative inference technique using a client device and a server.

### Description of the Related Art

Large Language Models (LLMs) demonstrate high performance across various tasks based on natural language. Many LLMs are developed by fine-tuning foundation models for specific tasks

Currently, LLMs are primarily provided as cloud-based services. Cloud servers provide high-performance computing resources necessary for model training and inference and can process large-scale data.

An expert model is a model fine-tuned for a specific task. Expert models may vary by task. In this case, the server must possess various personalized expert models.

### SUMMARY

In one or more aspects of the present disclosure, a collaborative inference method using a client device and a server includes: receiving, by the client device, first input data; generating, by the client device, a first embedding vector by inputting the first input data into a task-specific module; generating, by a server, a second embedding vector by inputting the first embedding vector into a task non-specific module; and producing, by the client device, a final inference result by inputting the second embedding vector into a decoding module.

In one or more aspects of the present disclosure, a client device includes: an interface device for receiving input data; a storage device storing a task-specific module and a decoding module; and a processor configured to generate a first embedding vector for the input data using the task-specific module and produce a final inference result by inputting a second embedding vector into the decoding module. The second embedding vector is calculated by a server inputting the first embedding vector into a task non-specific module.

In one or more aspects of the present disclosure, a server includes: a communication device for receiving a first embedding vector from a client device and transmitting a second embedding vector to the client device; a storage device storing a task non-specific module; and a processor for calculating the second embedding vector from the first embedding vector using the task non-specific module. The first embedding vector is calculated by the client device from input data using a task-specific module.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 illustrates an example comparing the time required during inference according to LLM size.

FIGS. 2A-2B illustrate an example of a conventional inference system.

FIGS. 3A-3B illustrate an example of a foundation model and a personalized expert model.

FIG. 4 illustrates an example of an inference system using models distributed between a client device and a server.

FIG. 5 illustrates an example of a collaborative inference process between a client device and a server.

FIG. 6 illustrates an example of the operation of a client device utilizing a personalized expert model.

FIG. 7 illustrates an example of the operation of a server supporting a foundation model of generative artificial intelligence.

FIG. 8 illustrates an example of a process for constructing a task-specific module on a client device.

FIG. 9 shows results of evaluating memory usage according to partitioning of a foundation model between an edge device and a cloud server.

FIG. 10 illustrates an example of a hardware apparatus participating in collaborative inference as a client device.

FIG. 11 illustrates an example of a server participating in collaborative inference.

Throughout the drawings and the detailed description, unless otherwise described, the same drawing reference numerals should be understood to refer to the same elements, features, and structures. The sizes of regions and elements, and depiction thereof may be exaggerated for clarity, illustration, and/or convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be understood by those of ordinary skill in the art.

Moreover, descriptions of well-known functions and constructions may be omitted for increased clarity and conciseness. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete to assist those skilled in the art to understand the inventive concepts without limiting the protected scope of the present disclosure.

Shapes, dimensions (e.g., sizes, lengths, locations, and areas), proportions, ratios, numbers, the number of elements, and the like disclosed herein, including those illustrated in the drawings, are merely examples, and thus, the present disclosure is not limited to the illustrated details. It is, however, noted that the relative dimensions of the components illustrated in the drawings are part of the present disclosure.

When the term “comprise,” “have,” “include,” “contain,” “constitute,” “made of,” “formed of,” “composed of,” or the like is used with respect to one or more elements (e.g., components, structures, groups, circuits, networks, members, parts, areas, portions, integers, steps, operations, and/or the like), one or more other elements may be added unless a term such as “only” or the like is used. The terms used in the present disclosure are merely used in order to describe particular example embodiments, and are not intended to limit the scope of the present disclosure. The terms of a singular form may include plural forms unless the context clearly indicates otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

When a positional relationship between two elements (e.g., components, structures, groups, circuits, networks, members, parts, areas, portions, and/or the like) are described using any of the terms such as “adjacent to,” “beside,” “next to,” and/or the like indicating a position or location, one or more other elements may be located between the two elements unless a more limiting term, such as “immediate(ly),” “direct(ly),” or “close(ly),” is used. Furthermore, the spatially relative terms such as the foregoing terms as well as other terms such as “column,” “row,” “vertical,” “horizontal,” “diagonal,” and the like refer to an arbitrary frame of reference.

In describing a temporal relationship, when the temporal order is described as, for example, “after,” “following,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

It is understood that, although the terms “first,” “second,” and the like may be used herein to describe various elements (e.g., components, structures, groups, circuits, networks, members, parts, areas, portions, and/or the like), these elements should not be limited by these terms, for example, to any particular order, precedence, or number of elements. These terms are used only to distinguish one element from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

The expression that an element (e.g., component, structure, group, circuit, network, member, part, area, portion, and/or the like) “is engaged” with another element may be understood, for example, as that the element may be either directly or indirectly engaged with the another element. The term “is engaged” or similar expressions may refer to a term such as “is connected,” “is coupled,” “is combined,” “is linked,” “is provided,” “interacts,” or the like. The engagement may involve one or more intervening elements disposed or interposed between the element and the another element, unless otherwise specified.

The terms such as a “line” or “direction” should not be interpreted only based on a geometrical relationship in which the respective lines or directions are parallel, perpendicular, diagonal, or slanted with respect to each other, and may be meant as lines or directions having wider directivities within the range within which the components of the present disclosure may operate functionally.

The term “at least one” should be understood as including any and all combinations of one or more of the associated listed items. For example, each of the phrases “at least one of a first item, a second item, or a third item” and “at least one of a first item, a second item, and a third item” may represent (i) a combination of items provided by two or more of the first item, the second item, and the third item or (ii) only one of the first item, the second item, or the third item. Further, at least one of a plurality of elements can represent (i) one element of the plurality of elements, (ii) some elements of the plurality of elements, or (iii) all elements of the plurality of elements. Further, “at least some,” “at least some portions,” “at least some parts,” “at least a portion,” “at least one or more portions,” “at least a part,” “at least one or more parts,” “at least some elements,” “one or more,” or the like of a plurality of elements can represent (i) one element of the plurality of elements, (ii) a portion (or a part) of the plurality of elements, (iii) one or more portions (or parts) of the plurality of elements, (iv) multiple elements of the plurality of elements, or (v) all of the plurality of elements. Moreover, “at least some,” “at least some portions,” “at least some parts,” “at least a portion,” “at least one or more portions,” “at least a part,” “at least one or more parts,” or the like of an element can represent (i) a portion (or a part) of the element, (ii) one or more portions (or parts) of the element, or (iii) the element, or all portions of the element.

The expression of a first element, a second elements “and/or” a third element should be understood as one of the first, second and third elements or as any or all combinations of the first, second and third elements. By way of example, A, B and/or C may refer to only A; only B; only C; any of A, B, and C (e.g., A, B, or C); some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

A phrase “substantially the same” may indicate a degree of being considered as being equivalent to each other taking into account minute differences due to errors in the manufacturing or operating process.

Features of various embodiments of the present disclosure may be partially or entirely coupled to or combined with each other, may be technically associated with each other, and may be variously operated, linked or driven together in various ways. Embodiments of the present disclosure may be implemented or carried out independently of each other or may be implemented or carried out together in a co-dependent or related relationship. In one or more aspects, the components of each apparatus and device according to various embodiments of the present disclosure are operatively coupled and configured.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in more detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for the convenience of description, a scale and dimension of each of the elements illustrated in the accompanying drawings may be different from an actual scale and dimension, and thus, embodiments of the present disclosure are not limited to a scale and dimension illustrated in the drawings.

Before starting detailed explanations of figures, components that will be described in the specification are distinguished merely according to functions mainly performed by the components. That is, two or more components which will be described later can be integrated into a single component. Furthermore, a single component which will be explained later can be separated into two or more components. Moreover, each component which will be described can additionally perform some or all of a function executed by another component in addition to the main function thereof. Some or all of the main function of each component which will be explained can be carried out by another component. Accordingly, presence/absence of each component which will be described throughout the specification should be functionally interpreted.

The artificial intelligence model may be any one of various types of models. The artificial intelligence model may be a model that receives at least one of various types of data such as text and images and performs inference. The artificial intelligence model may be any one of models with various structures such as Multi-Layer Perceptron (MLP), Convolutional Neural Network (CNN), and transformer. However, for convenience of explanation below, the natural language processing model will be described focusing on LLMs. That is, it is assumed that input data is text in natural language. An LLM may be a model that produces the next sentence or answer based on the input text.

A foundation model is a general-purpose artificial intelligence model pre-trained with large-scale data. An expert model is a model in which a foundation model has been fine-tuned for a specific task.

The server may be a physical server, cloud server, etc.

The server may have at least some modules of the foundation model and process input data or vectors.

The client device may be at least one of various types of devices such as user terminals, smart devices, PCs, IoT devices, vehicles, and edge devices. The client device may have a task-specific model among foundation models and process input data.

First, the LLM structure will be briefly described.

An LLM may comprise an embedding module, transformer blocks, and a decoding module. The embedding module receives the original text, divides it into multiple tokens, and embeds each token to generate a vector. The transformer blocks receive the embedded vector and perform attention and feed-forward operations. The transformer blocks learn complex relationships and patterns in the data to process the data. Therefore, transformer blocks generally require a large amount of computation. The decoding module calculates probabilities over tokens using the output of the transformer block through a single linear layer, and a tokenizer decodes the tokens into sentences.

The transformer structure is a core component in LLMs. Transformer blocks extract relationships between words and input values and generate certain outputs based on this. Various types and sizes of LLM models have been developed.

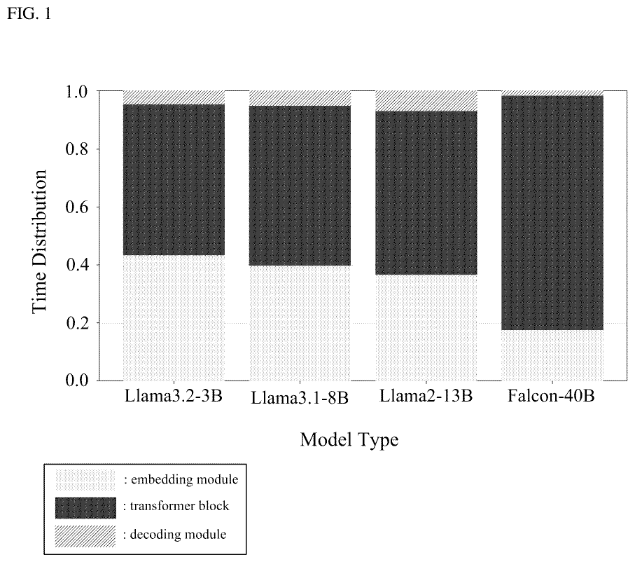

FIG. 1 illustrates an example comparing the time required during inference according to LLM size. FIG. 1 illustrates an example of comparing models with different parameter sizes. Parameter sizes are indicated in B (billion). Referring to FIG. 1, it can be seen that as the model size increases, the computational load of the transformer increases.

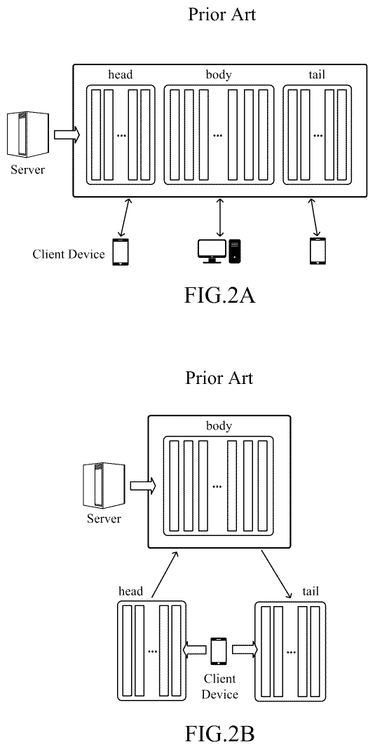

FIGS. 2A-2B illustrate an example of a conventional inference system utilizing a server.

FIG. 2A illustrates an example of a conventional cloud-based inference system. In FIG. 2A, the server provides inference services using the entire neural network model. The client device transmits input data to the server, the server inputs the input data to the neural network model to perform inference, and transmits the inference result to the client device. That is, in FIG. 2A, the client device receives certain inference services using the centralized server. In the case of FIG. 2A, the neural network model on the server must be prepared in advance as different models for each specific task.

FIG. 2B illustrates an example of another conventional inference system. FIG. 2B illustrates an example of collaborative inference between a server and a client device. FIG. 2B illustrates an example in which one foundation model is partitioned (see Ohta et al., Λ-Split: A Privacy-Preserving Split Computing Framework for Cloud-Powered Generative AI, CoRR 2023). The neural network model involved in the inference system of FIG. 2B may be uniformly partitioned between the server and the client device. The client device may have layers (head) located at the front and layers (tail) located at the rear of the neural network model. The server may have layers (body) located in the middle of the neural network model. The client device inputs input data to the front layers (head), processes it, and transmits the embedding vector to the server. The server inputs the embedding vector transmitted by the client device to the neural network model (body) to calculate a certain intermediate vector and transmits it to the client device. The client device may obtain a certain inference result by inputting the intermediate vector to the last layers (tail). In the case of FIG. 2B, the neural network models partitioned between the server and the client device are general foundation models. Therefore, if it is a personalized expert model, those models must be partitioned between the server and the client device in different ways (without shared weights).

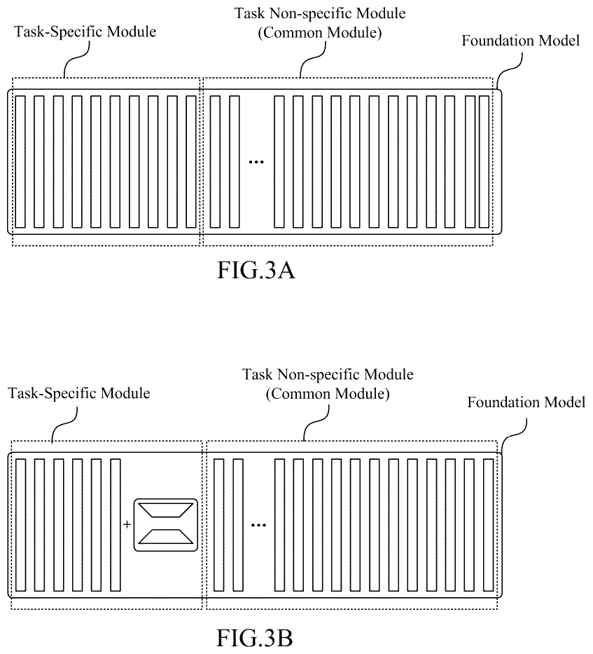

FIGS. 3A-3B illustrate an example of personalized expert models partitioned between a server and a client device. A personalized expert model is a model constructed based on a foundation model for a specific task. An expert model may include task-non-specific modules (common modules) and task-specific modules.

FIG. 3A illustrates an example of a personalized expert model to which a general fine-tuning method has been applied. The personalized expert model of FIG. 3A includes task-specifically fine-tuned layers (task-specific modules) and layers that have not been fine-tuned (task-non-specific modules, common modules) among the foundation model. In FIG. 3A, the task-specific module is assigned to the client device, and the task-non-specific module (common module) is assigned to the server. The task-specific module is generated through a task-specific fine-tuning process. The task-non-specific module (common module) receives information output by the task-specific model and performs certain inference regardless of the task.

FIG. 3B illustrates an example of a personalized expert model to which Parameter-Efficient Fine-Tuning (PEFT) has been applied. The personalized expert model of FIG. 3B includes task-specifically fine-tuned layers (task-specific modules) and layers that have not been fine-tuned (task-non-specific modules, common modules) among the foundation model. The task-specific module of FIG. 3B is a model to which PEFT has been applied. The task-specific module of FIG. 3B may include layers to which Low-Rank Adaptation (LoRA) or other quantization has been applied. The task-specific module may have a certain level of reduction or quantization applied according to the specific task and specific client device specifications. The task-specific module is assigned to the client device, and the task-non-specific module (common module) is assigned to the server.

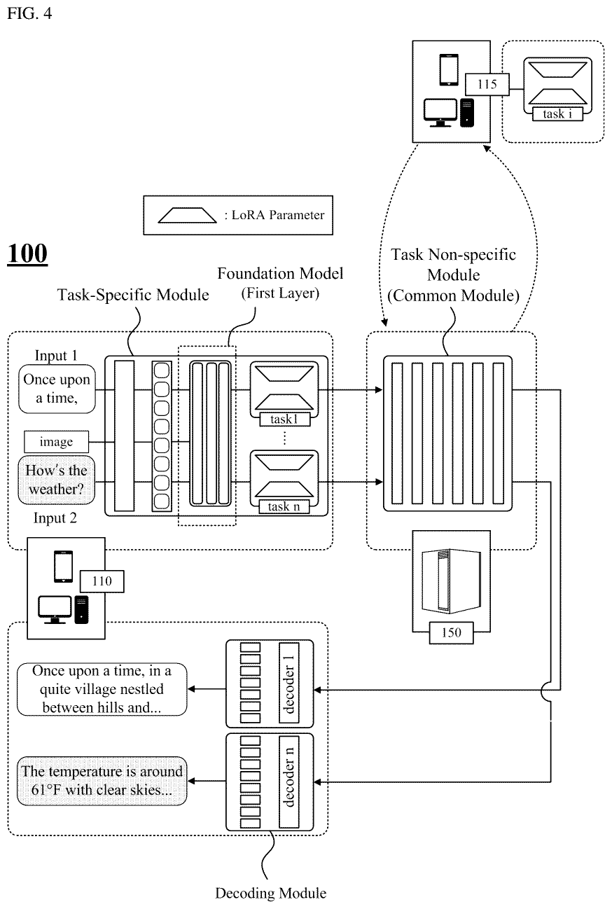

FIG. 4 illustrates an example of an inference system 100 using models distributed between a client device and a server. In the inference system 100 of FIG. 4, the server holds the same task-non-specific module regardless of the type of task, and only the client device holds task-specific model layers.

The inference system 100 includes a client device 110 and a server 150. FIG. 4 illustrates the client device 110 as an example.

The client device 110 and the server 150 partition the entire model and process it collaboratively.

The foundation model may be partitioned and assigned to the client device 110 and the server 150. The foundation model is generally a neural network trained through unsupervised learning on raw data. The foundation model may have a structure in which transformer blocks are the core. The client device 110 may have the front layer(s) of the foundation model. The front layer of the foundation model corresponds to the layer that receives the vector output from the embedding layer. For convenience of explanation, the front layer of the foundation model deployed to the client device 110 is referred to as the first layer. The first layer may comprise multiple layers. The server 150 has the remaining layers excluding the front layer of the foundation model. The remaining layers of the foundation model deployed to the server 150 are referred to as the second layer. The second layer may comprise multiple layers. That is, the server 150 has multiple transformer blocks among the computationally intensive transformer blocks and participates in inference.

The client device 110 includes a task-specific module. FIG. 4 shows the client device 110 processing n tasks. Task 1 is an example of generating certain text content (poetry, novels, etc.) based on input text, and task n exemplifies a question and answering (Q&A) service.

The client device 110 may further receive different modal data depending on the task. That is, the client device 110 may receive multimodal data. For example, the client device 110 may receive images and sentences together.

The task-specific module generates an embedding vector for input data.

The task-specific module may include a tokenizer, transformer layers, and a fine-tuned adapter. The tokenizer converts input sentences into a token set and converts them into embedding vectors. The aforementioned first layer of the foundation model may include at least some of the transformer layers.

A task-specific LoRA adapter may be applied as the adapter. A LoRA adapter is a component prepared in advance for each specific task. In this case, the task-specific module may process different tasks by swapping LoRA adapters. FIG. 4 is an example where task 1 and task n have different adapter structures.

LoRA is a technique for fine-tuning the weights of a pre-trained model using low-rank matrix decomposition. LoRA fixes the weights of the pre-trained model and uses trainable matrices to perform tasks. LoRA transforms the forward propagation path h=W₀x as shown in Equation 1 below.

$$h = {W}_{0} x + Δ W x = {W}_{0} x + B A x \qquad [ Equation 1 ]$$

where W₀∈ [symbol] ^{d×k} represents the pre-trained weights. And, B∈ [symbol] ^{d×r} and A∈ [symbol] ^{r×k} are trainable low-rank matrices with rank r<<min(d,k).

LoRA may apply adapters to layers to be added, and are generally added within MLP or attention blocks. LoRA may implement task-specific models by swapping adapters.

Meanwhile, the client device may apply quantization to a given model configuration. For example, the client device may apply QLoRA-based 4-bit quantization to large models. However, the client device may perform quantization on some of the layers assigned to it.

In FIG. 4, the task-specific module is an example that includes a LoRA adapter. Furthermore, the task-specific module may be a model in which task-specific fine-tuning has been performed on all layers rather than quantization.

The server 150 holds a task-non-specific module (common module) corresponding to the original layer among the foundation model. The task-non-specific module (common module) receives the vector of tokens output by the LoRA adapter of the client device 110 and performs processing of the transformer block.

Thereafter, the client device 110 performs post-processing. The client device 110 includes a decoding module. The decoding module receives the transformer block output from the server 150, derives probabilities for the token map, and decodes it into a certain text sentence. Meanwhile, the decoding module may be constructed in advance as different modules for each task. In some cases, the decoding module may be one common module for multiple tasks.

In summary, the client device 110 performs task-specific embedding, adaptation using a LoRA adapter, and decoding to convert vectors processed in the foundation model into sentences that are the task target. The server 150 performs certain operations and processing using the foundation model regardless of the task. That is, the client device 110 performs task-specific data processing. The server 150 processes vectors transmitted to the client device 110 using transformer blocks regardless of the task and transmits the processed token vectors back to the client device 110.

Meanwhile, the task that the client device 110 performs or requests may be different from another client device 115. In this case, the client device 110 and the client device 115 may have different structures for task-specific modules or LoRA adapters. The client device 115 may perform operations similar to the client device 110. The client device 115 may transmit an embedding vector generated using its task-specific module based on input data to the server 150. The client device 115 may receive the embedding vector generated by the server 150, input the received embedding vector to its decoding module, and produce a certain inference result.

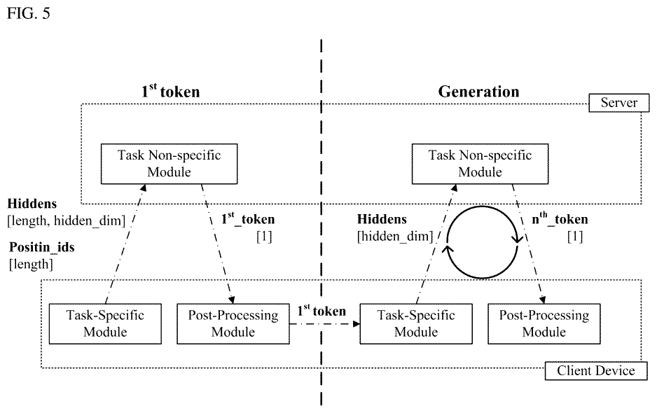

FIG. 5 illustrates an example of a collaborative inference process between a client device and a server. In FIG. 5, “[ ]” indicates the form of data transmitted. “length” is the length, and “hidden_dim” is the dimension of the hidden layer.

Algorithm 1 in Table 1 below is pseudocode for the process performed on the client device.

TABLE 1
Algorithm 1 Client Generate Loop

```
Input: inputs x, Pre-processing Module, Task-Specific Module, MAX_TOKEN, Tokenizer
Initialize network connection to the server
tokens = Tokenizer(x)
for i = 0 to MAX_TOKEN do
  if i == 0 then
    pos = PRE-PROCESSING(tokens)
    hidden = TASK-SPECIFIC(tokens, pos)
  else
    pos = PRE-PROCESSING(tokenᵢ₋₁)
    hidden = TASK-SPECIFIC(tokenᵢ₋₁, pos)
  end if
  SEND(hidden, pos)
  tokenᵢ = RECEIVE( )
  if tokenᵢ == EOF then
    return POST-PROCESSING([token₀, . . . , tokenᵢ])
  end if
end for
return POST-PROCESSING([token₀, . . . , tokenᵢ])
close_connection( )
```

Algorithm 1 is briefly described. The client device divides the input text into multiple tokens. The client device vectorizes each token using a tokenizer. The client device calculates token position information (pos) for the initial entire token and generates an embedded vector (hidden) through the task-specific module. The client device performs the embedding process for each token.

Algorithm 2 in Table 2 below is pseudocode for the process performed on the server.

The server initializes the cache and uses the held task-non-specific module to process the token vector received from the client device and transmits the generated token vector to the client device. In Table 2, Foundation( ) refers to the foundation module (task-non-specific module) that is task-non-specific among the entire model.

TABLE 2
Algorithm 2 Server Generate Loop

```
Input: Foundation Module, cache_{c}: Cache for client c
that saves past key values
while TRUE do
  if Connected to client c then
    hidden, pos = RECEIVE( )
    if cache_{c} is empty then
      init cache_{c}
    end if
    token = FOUNDATION(cache_{c}, hidden, pos)
    SEND(token)
  else
    empty cache_{c}
  end if
end while
```

The client device performs post-processing on each received token vector, and when post-processing is completed up to the last token, outputs the result for all tokens.

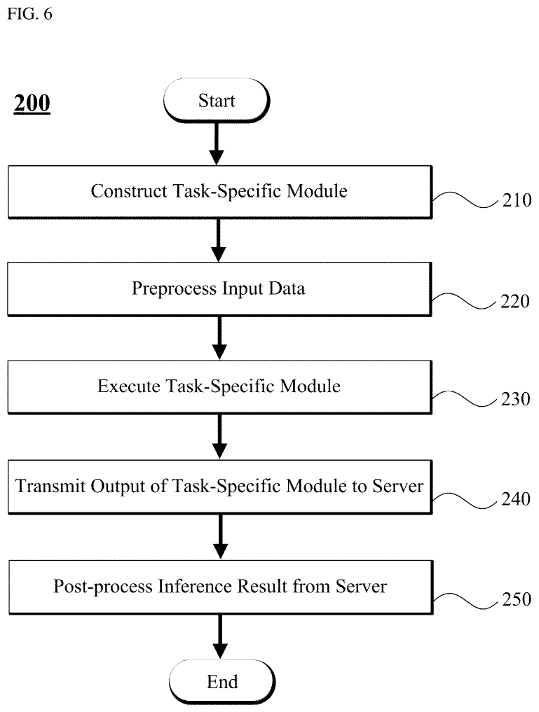

FIG. 6 illustrates an example of the operation 200 of a client device utilizing a personalized expert model. FIG. 6 corresponds to the operation of the client device 110 in FIG. 4.

The client device first constructs a task-specific module on that device (210).

The client device receives or collects input data. The client device may process the input data uniformly (220). For example, the client device may tokenize the input data.

The client device inputs the processed input data and executes the task-specific module (230). The task-specific module receives input data and outputs a certain embedding vector.

The client device transmits the output value of the task-specific module to the server (240). The server performs certain operations or processing using its task-non-specific module.

The client device post-processes the operation result received from the server (output of the task-non-specific module) to derive an inference result (250). The client device may input the output value of the task-non-specific module to the decoding module to produce a certain inference result.

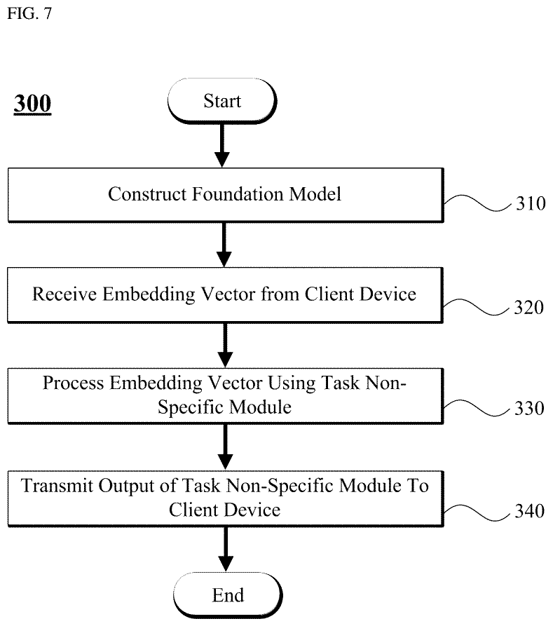

FIG. 7 illustrates an example of the operation 300 of a server supporting a foundation model of generative artificial intelligence. FIG. 7 corresponds to the operation of the server 150 in FIG. 4.

The server constructs a foundation model (310). The foundation model may use a pre-built baseline model. The server holds a task-non-specific module (common module) among the foundation model.

The server receives an embedding vector output by the task-specific module from the client device (320).

The server inputs the embedding vector to the task-non-specific module to process the embedding vector (330).

The server transmits the output value of the task-non-specific module to the client device (340).

The client device constructs a task-specific module as described above. Multiple client devices may construct different task-specific modules. Furthermore, one client device may also construct multiple task-specific modules.

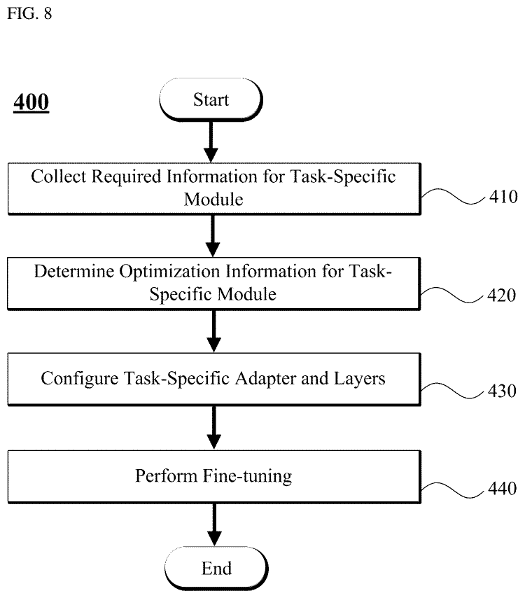

FIG. 8 illustrates an example of a process 400 for constructing a task-specific module on a client device. FIG. 8 illustrates an example of constructing a specific task-specific module on one client device.

The client device may first collect information necessary for the task-specific module (410). The information collected at this time may include the performance of the client device, the target task, and task-specific module information (layer depth, weight size, etc.).

The client device may determine whether to quantize layers, the degree of quantization (4 bit, 8 bit, 32 bit, etc.), layer pruning, etc., based on its performance (memory, computing capability, etc.) and information on the task-specific module (420). That is, the client device may determine information for optimization of layers assigned to it.

The client device may configure its (LoRA adapter) and layers based on the optimization information (430).

The client device may perform fine-tuning on the task-specific module using training data to generate the task-specific module (440).

The performance of the distributed model described above was evaluated. Two different foundation models, Llama and Falcon, were used for evaluation.

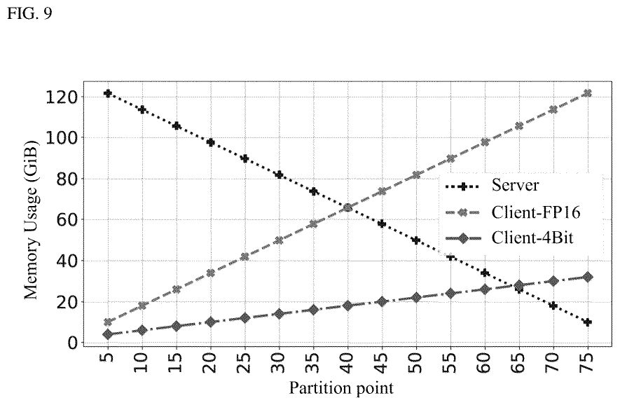

The evaluation examined the relationship between the computational load and the point at which the foundation model is partitioned between the client device and the server. FIG. 9 shows the results of evaluating memory usage according to the partitioning of the foundation model between the client device and the server. FIG. 9 evaluated memory usage (GB, Gibibyte) according to the degree of partitioning of the foundation model between the client device and the server based on the Llama3.1-70B model. Since the model is loaded and processed using floating-point (FP) 16 precision, the total memory requirement is approximately 140 GB.

In FIG. 9, the horizontal axis represents the number of layers used by the client device among the total 80 layers of the foundation model. As more layers are deployed to the client device, more memory is required. Looking at FIG. 9, it can be seen that the foundation model may be appropriately deployed to the client device according to the server's computing capacity, the size of the LLM model, and the computing capacity of the client device. Also, when the client device uses a quantized model (Client-4 Bit), memory usage is reduced compared to a model without quantization (Client-FP16).

Model performance was evaluated based on representative LLM service tasks: language modeling, summarization, and Q&A. For language modeling, the WikiText2 dataset was used and performance was evaluated based on perplexity. For summarization, the SAMsum dataset was used and the BLEU score was measured. For Q&A, the MedQA dataset was used and accuracy was assessed. Table 3 below shows the performance according to the amount of layers deployed to the client device for each task. It can be seen that when the model size is not very large, the more fine-tuned layers are deployed to the client device, the higher the model performance. However, when the model size becomes large (Llama3.1-70B), the case where 20 fine-tuned layers are deployed to the client device showed higher performance. These results suggest that if the model size is large, applying LoRA adapters to some layers on the client device shows sufficient performance.

TABLE 3

| | | Dataset | | |
|---|---|---|---|---|
| Model | Partition | WikiText2(Perplexity↓) | SAMSum(BLEU↑) | MedQA(Accuracy↑) |
| Llama3.2- | 0 (w/o | 13.52 | 3.64 | — |
| 3B | fine-tune) | | | |
| | 4 | 9.79 | 18.43 | 37.01 |
| | 8 | 9.45 | 17.07 | 42.13 |
| | 12 | 9.26 | 18.72 | 41.73 |
| | 16 | 9.14 | 19.91 | 42.32 |
| | 20 | 9.04 | 19.26 | 40.75 |
| | 24 | 8.80 | 20.26 | 43.50 |
| | 28 | 8.65 | 19.22 | 43.66 |
| Llama3.1- | 0 (w/o | 11.30 | 4.29 | — |
| 8B | fine-tune) | | | |
| | 4 | 8.06 | 15.30 | 47.69 |
| | 8 | 7.74 | 15.63 | 51.22 |
| | 12 | 7.65 | 17.20 | 53.40 |
| | 16 | 7.58 | 17.06 | 49.75 |
| | 20 | 7.51 | 17.06 | 48.57 |
| | 24 | 7.33 | 16.60 | 55.36 |
| | 28 | 7.18 | 16.94 | 49.95 |
| | 32 | 7.04 | 16.71 | 54.47 |
| Falcon2- | 0 (w/o | 6.59 | 6.19 | — |
| 11B | fine-tune) | | | |
| | 5 | 5.68 | 23.49 | 46.46 |
| | 10 | 5.56 | 23.56 | 41.93 |
| | 15 | 5.52 | 21.98 | 48.82 |
| | 20 | 5.51 | 22.29 | 43.70 |
| | 25 | 5.50 | 22.79 | 46.65 |
| | 30 | 5.49 | 23.09 | 48.62 |
| | 35 | 5.48 | 22.14 | 49.21 |
| | 40 | 5.48 | 22.56 | 50.20 |
| | 45 | 5.47 | 22.41 | 46.41 |
| | 50 | 5.47 | 21.92 | 46.51 |
| | 55 | 5.46 | 22.16 | 45.33 |
| | 60 | 5.45 | 21.26 | 49.41 |
| Llama3.1- | 0 (w/o | 5.12 | 7.22 | — |
| 70B | fine-tune) | | | |
| | 20 | 3.192 | 22.28 | 74.24 |
| | 40 | 3.26 | 22.78 | 70.70 |
| | 60 | 3.25 | 21.38 | 70.89 |
| | 80 | 3.23 | 21.42 | 69.71 |

In the above description, LLMs were the focus. However, the inference technique using partitioned models between the client device and the server described above may be applied to models other than LLMs.

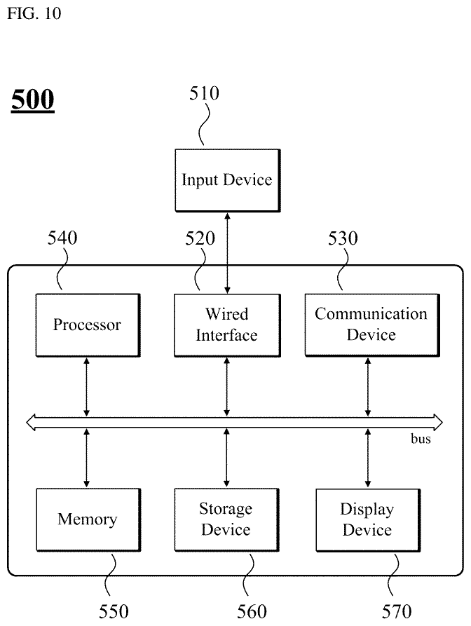

FIG. 10 illustrates an example of a hardware device 500. The hardware device 500 corresponds to a client device participating in collaborative inference. The hardware device 500 may be implemented in various physical forms. For example, the client device 500 may take the form of a PC, smart device, vehicle, robot, IoT device, etc.

The hardware device 500 may include an input device 510, a wired interface 520, a communication device 530, a processor 540, a memory 550, and a storage device 560.

Alternatively, the hardware device 500 may include an input device 510, a wired interface 520, a communication device 530, a processor 540, a memory 550, a storage device 560, and a display device 570.

Each internal component of the hardware device 500 may be connected by a bus. Depending on the type of entity being connected, a specific bus may be used. For example, the bus may be any one of AMBA (AHB/AXI/APB), PCIe, Serial Peripheral Interface (SPI), or Mobile Industry Processor Interface (MIPI).

The input device 510 is a device that receives user commands or information.

Also, the input device 510 may be a device that receives necessary data from an external device or storage device connected physically.

The input device 510 may receive input data from a user. The input data may be any one of various types of data such as text, images, and audio.

The input device 510 may be any one of various types of devices. For example, the input device 510 may be at least one of a mouse, keyboard, touch input device, camera, Small Computer System Interface (SCSI) device, Peripheral Component Interconnect (PCI) bus-based device, or ATA Packet Interface (ATAPI) device.

The wired interface 520 is a device component that transmits data transmitted by the input device 510 to the inside of the device. The wired interface 520 may comprise software drivers and hardware.

The wired interface 520 may include a controller corresponding to each input device, a device driver that controls the operation of the controller, and a kernel I/O subsystem that comprehensively manages input/output control requests from the device driver. The kernel I/O subsystem stores input/output requests from device drivers in a queue and schedules the requests based on request priority or device status.

The wired interface 520 may include interfaces such as PS/2, Universal Serial Bus (USB), Ethernet port, HDMI, MIPI CSI, DisplayPort, and Thunderbolt.

The wired interface 520 may transmit inference results using an artificial intelligence model to other components inside the hardware device 500 or to external objects.

The communication device 530 refers to a component that receives and transmits certain information through an external wired or wireless network. The communication device 530 may comprise a circuit including an antenna and a communication module (S/W module, chip, etc.) corresponding to the communication protocol. The communication protocol may be at least one of wired LAN (Ethernet), wireless LAN (IEEE 802.11), mobile communication (LTE, 5G NR, etc.), Bluetooth, and NFC.

The communication device 530 may receive input data from an external object. The input data may be any one of various types of data such as text, images, and audio.

The communication device 530 may transmit vectors or token vectors calculated using the task-specific module to the server. At this time, the vectors may be task-specific vectors generated through the LoRA adapter.

The communication device 530 may also transmit inference results using an artificial intelligence model to external objects such as user terminals or separate servers.

The processor 540 controls the operation of all components of the hardware device 500. Also, the processor 540 controls the visualization process of simulation data.

The processor 540 may perform operations on at least one application or computer program for executing methods/operations according to various embodiments of the present disclosure.

The processor 540 is a general-purpose processor that executes at least some of the control programs installed in the storage device 560 or at least some of the programs loaded in the memory 550.

The processor 540 may be implemented as circuitry such as a system on chip (SoC) or integrated circuit (IC).

The processor 540 may include one or more processors. For example, the processor 540 may include a combination of one or more processors such as a central processing unit (CPU), microprocessor unit (MPU), micro controller unit (MCU), graphic processing unit (GPU), neural processing unit (NPU), digital signal processor (DSP), application processor (AP), communication processor (CP), or any form of processor well known in the technical field of the present disclosure.

The memory 550 may store data generated during the process of the client device processing data using deployed model layers. The memory 550 is volatile memory such as DRAM or SRAM.

The storage device 560 may store input data. The input data may be any one of various types of data such as text, images, and audio.

The storage device 560 may store some components of the artificial intelligence model. The some components may comprise some layers that performs task-specific processing. In the case of LLMs, the storage device 560 may store (1) an embedding layer that processes initial input data, (2) a task-specific module, and (3) a task-specific decoding module. The task-specific module may comprise at least one of task-specifically fine-tuned layers, a task-specific quantization module, and a task-specific LoRA adapter.

The storage device 560 may store inference results using the artificial intelligence model. For example, the storage device 560 may store final output information (text or sentences) based on the LLM model.

The storage device 560 may be implemented as a device such as a hard disk drive, Solid State Drive, USB flash drive, memory card, optical disk, or network-based storage device (Network Attached Storage, cloud storage, etc.).

The display device 570 may output interfaces necessary for the processing process, inference results, etc.

The display device 570 may be implemented as various types of devices.

The display device 570 may be implemented by various display methods such as liquid crystal, plasma, light-emitting diode, organic light-emitting diode, surface-conduction electron-emitter, carbon nano-tube, and nano-crystal.

The processor 540 may uniformly preprocess input data. Preprocessing may include noise removal, normalization, etc.

The processor 540 may divide input data that is text into certain tokens. In some cases, the processor 540 may also divide images into multiple tokens (patches). In the latter case, it is when a model such as ViT is partitioned between the client device and the server.

The processor 540 may uniformly embed input data or tokens using an embedding layer.

The processor 540 may perform adaptation on the embedding vector using a task-specific LoRA adapter. The embedding vector calculated by applying the LoRA adapter may be transmitted to the server.

The processor 540 may input the vector calculated by the task-non-specific module of the server to the decoding module to produce a task-specific result. At this time, the task-specific result may be any one of a certain sentence, an answer to a question, a query result, etc.

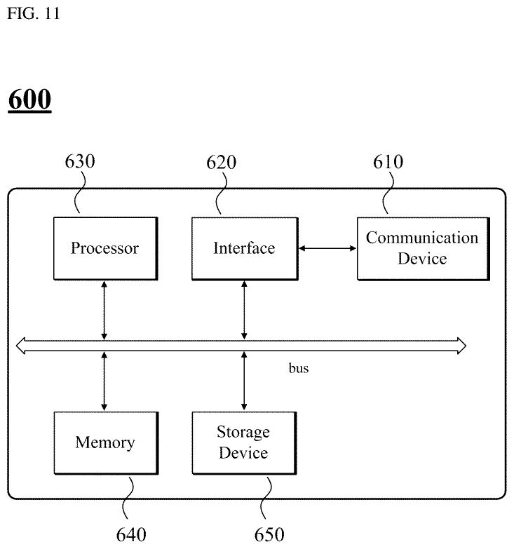

FIG. 11 illustrates an example of a server 600 participating in collaborative inference. The server 600 includes a communication device 610, an interface 620, a processor 630, a memory 640, and a storage device 650.

Each internal component of the server 600 may be connected by a bus. Depending on the type of entity being connected, a specific bus may be used. For example, the bus may be at least one of various interfaces such as QPI/UPI, DDR memory bus, NVMe, SATA, SAS, PC, and SPI.

The communication device 610 is a device through which the server transmits and receives data with external networks or other devices. The communication device 610 may transmit and receive information with client devices.

The communication device 610 may comprise a circuit including an antenna and a communication module (S/W module, chip, etc.) corresponding to the communication protocol. At this time, the communication protocol may be at least one of wired LAN (Ethernet), wireless LAN (IEEE 802.11), and mobile communication (LTE, 5G NR, etc.).

The communication device 610 may receive vectors or token vectors calculated using the task-specific module of the client device from the client device. At this time, the vectors may be task-specific vectors generated through the LoRA adapter.

The communication device 610 may transmit vectors calculated using the task-non-specific module (common module) corresponding to the original layer among the foundation model to the client device. At this time, the task-non-specific module receives task-specific vectors generated by the client and calculates certain vectors. That is, the communication device 610 transmits intermediate vectors obtained by processing the task-specific vectors of the client device with the task-non-specific module back to the client device.

The interface 620 is a component connected to the communication device 610 to support data exchange between the server 600 and external devices. The interface 620 may perform data format conversion, transmission protocol conversion, or port control functions when interworking with client devices, external storage devices, management devices, etc.

The interface 620 may support various communication standards such as Ethernet, USB, PCI Express, Infiniband, SATA, SAS, NVMe, and RS-232.

The processor 630 controls the operation of all components of the server 600.

The processor 630 may perform operations on at least one application or computer program for executing methods/operations according to various embodiments of the present disclosure.

The processor 630 is a general-purpose processor that executes at least some of the control programs installed in the storage device 650 or at least some of the programs loaded in the memory 640.

The processor 630 may be implemented as a circuit such as a system on chip or integrated circuit.

The processor 630 may include one or more processors. For example, the processor 630 may include a combination of one or more processors such as CPU, MPU, MCU, GPU, NPU, DSP, AP, CP, or any form of processor well known in the technical field of the present disclosure.

The processor 630, as the central processing unit of the server, executes programs stored in the memory 640 or storage device 650 and controls the overall operation of the server. The processor 630 provides control signals to each component (memory, storage device, interface, communication device, etc.) connected through the bus and receives and processes data from these components.

The memory 640 may store data generated during the server's data processing and neural network module (task-non-specific module) operation process. The memory 640 is volatile memory such as DRAM or SRAM.

The storage device 650 may store task-specific vectors received from the client device, etc.

The storage device 650 stores a task-non-specific module (common module) corresponding to the original layer among the foundation model.

The storage device 650 is a non-volatile storage device and may be implemented as a device such as a hard disk drive, solid state drive, USB flash drive, memory card, optical disk, or network-based storage device.

The processor 630 may input task-specific vectors received from the client device to the task-non-specific module (common module) to calculate intermediate vectors. The task-non-specific module (common module) may receive vectors of tokens output by the LoRA adapter of the client device and perform processing of the transformer block.

Methods according to the embodiments described in the specification of the present disclosure may be implemented in the form of hardware, software, or a combination of hardware and software.

When implemented as software, a computer-readable storage medium storing one or more programs (software modules) may be provided. One or more programs stored in the computer-readable storage medium are configured for execution by one or more processors within an electronic device. One or more programs include instructions that cause the electronic device to execute methods according to the embodiments described in the specification of the present disclosure.

The non-transitory computer readable medium refers to a medium that stores data semi-permanently (e.g., the storage device) and is capable of being read by a device, rather than a medium that stores data for a short period of time, such as a register, cache, or memory. Specifically, the various applications or programs described above may be provided by being stored in the non-transitory computer readable medium such as a CD, a DVD, a hard disk, a Blu-ray disk, a USB, a memory card, a read-only memory (ROM), a programmable read only memory (PROM), an erasable PROM (EPROM), an electrically EPROM (EEPROM), or a flash memory.

The transitory computer readable medium refers to various types of RAM such as a static RAM (SRAM), a dynamic RAM (DRAM), a synchronous DRAM (SDRAM), a double data rate SDRAM (DDR SDRAM), an enhanced SDRAM (ESDRAM), a synclink DRAM (SLDRAM), and a direct Rambus RAM (DRRAM).

Various examples and aspects of the present disclosure are described below. These are provided as examples, and do not limit the scope of the present disclosure.

The description herein has been presented to enable any person skilled in the art to make, use and practice the technical features of the present disclosure, and has been provided in the context of one or more particular example applications and their example requirements. Various modifications, additions and substitutions to the described embodiments will be readily apparent to those skilled in the art, and the principles described herein may be applied to other embodiments and applications without departing from the scope of the present disclosure. The description herein and the accompanying drawings provide examples of the technical features of the present disclosure for illustrative purposes. In other words, the disclosed embodiments are intended to illustrate the scope of the technical features of the present disclosure. Thus, the scope of the present disclosure is not limited to the embodiments shown, but is to be accorded the widest scope consistent with the claims. The scope of protection of the present disclosure should be construed based on the following claims, and all technical features within the scope of equivalents thereof should be construed as being included within the scope of the present disclosure.

What is claimed is:

1. A method for collaborative inference using a client device and a server, comprising:
receiving, by the client device, first input data;
generating, by the client device, a first embedding vector by inputting the first input data into a task-specific module;
generating, by the server, a second embedding vector by inputting the first embedding vector into a task non-specific module; and
producing, by the client device, a final inference result by inputting the second embedding vector into a decoding module,
wherein the task-specific module is a model trained specifically for one task,
wherein the task non-specific module is a model common to various tasks, and
wherein the task-specific module, the task non-specific module, and the decoding module constitute a personalized expert model.

2. The method of claim 1, wherein the expert model is a large language model (LLM).

3. The method of claim 1, wherein the task-specific module comprises at least one of: a layer fine-tuned specifically for the one task from some layers of a foundation model, a layer quantized specifically for the one task from some layers of the foundation model, and a LoRA adapter specific to the one task from some layers of the foundation model.

4. The method of claim 1, wherein the task-specific module comprises layers trained specifically for the one task among layers of a foundation model, and
wherein the task non-specific module comprises at least some layers among layers of the foundation model excluding the trained layers.

5. The method of claim 1, wherein the decoding module is a neural network pre-trained to perform task-specific operations.

6. The method of claim 1, further comprising:
transmitting, by a second client device, a third embedding vector calculated by inputting second input data into its task-specific module to the server;
receiving, by the second client device, a fourth embedding vector generated by the server by inputting the third embedding vector into the task non-specific module; and
producing, by the second client device, a final inference result by inputting the fourth embedding vector into a decoding module.

7. A client device participating in collaborative inference, comprising:
an interface device for receiving input data;
a storage device storing a task-specific module and a decoding module; and
a processor configured to generate a first embedding vector for the input data using the task-specific module and produce a final inference result by inputting a second embedding vector into the decoding module,
wherein the second embedding vector is calculated by a server inputting the first embedding vector into a task non-specific module,
wherein the task-specific module is a model trained specifically for one task, and
wherein the task non-specific module is a model common to various tasks.

8. The client device of claim 7,
wherein the task-specific module, the task non-specific module, and the decoding module constitute a personalized expert model, and
wherein the expert model is a large language model (LLM).

9. The client device of claim 7, wherein the task-specific module includes at least one of: a layer fine-tuned specifically for the one task from some layers of a foundation model, a layer quantized specifically for the one task from some layers of the foundation model, and a LoRA adapter specific to the one task from some layers of the foundation model.

10. The client device of claim 7, wherein the task-specific module comprises layers trained specifically for the one task among layers of a foundation model, and
wherein the task non-specific module comprises at least some layers among layers of the foundation model excluding the trained layers.

11. The client device of claim 7, wherein the decoding module is a neural network pre-trained to perform task-specific operations.

12. A server participating in collaborative inference, comprising:
a communication device for receiving a first embedding vector from a client device and transmitting a second embedding vector to the client device;
a storage device storing a task non-specific module; and
a processor for calculating the second embedding vector from the first embedding vector using the task non-specific module,
wherein the first embedding vector is calculated by the client device from input data using a task-specific module,
wherein the task-specific module is a model trained specifically for one task, and
wherein the task non-specific module is a model common to various tasks.

13. The server of claim 12, wherein the task-specific module includes at least one of: a layer fine-tuned specifically for the one task from some layers of a foundation model, a layer quantized specifically for the one task from some layers of the foundation model, and a LoRA adapter specific to the one task from some layers of the foundation model.

14. The server of claim 12, wherein the task-specific module comprises layers trained specifically for the one task among layers of a foundation model, and
wherein the task non-specific module comprises at least some layers among layers of the foundation model excluding the trained layers.
